(19) United States
(12) Patent Application Publication
(10) Pub. No.: US 2008/0182560 A1
(43) Pub. Date: Jul. 31, 2008

(54) Messaging Method and Server

(76) Inventor: Magnus Beije, Sollentuna (SE)

Correspondence Address: COATS & BENNETT, PLLC, 1400 Crescent Green, Suite 300, Cary, NC, 27518, US

(21) Appl. No.: 11/964,959

(22) Filed: Dec. 27, 2007

(30) Foreign Application Priority Data
Dec. 28, 2006 (EP) 06127305-8

(51) Int. Cl. H04Q 7/00

(52) U.S. Cl. 455/412.2

(57) ABSTRACT

A messaging server receives a request from a first communication device to send a video message to a second communication device. The server transmits a video message initiation to the first communication device and receives a live feed video signal from the first communication device in response. The server stores the received video signal as a video message, and transmits a notification to the second communication device to for each video message. Upon receiving a request from the second communication device to send the stored video message, the message server transmits the video message to the second communication device as a live feed video signal.

### RELATED APPLICATIONS

This application claims priority from a foreign patent application having serial number EP 06127305. That application, which is entitled, “Messaging Method and Server,” was filed on Dec. 28, 2006, and is incorporated herein by reference in its entirety.

### TECHNICAL FIELD

The present invention relates to a method of communicating messages in a communication network. The present invention also relates to a corresponding messaging server, and to a computer program product comprising code for communicating the messages.

### BACKGROUND

In the field of cellular communications, the ability to communicate via both voice and messaging has become very popular, and a number of communication standards have been defined. One such standard is the global system for mobile communications (GSM), defined by the European Telecommunication Standards Institute (ETSI). Within the GSM standard, a supplementary messaging service standard, known as a short message service (SMS) standard, has been defined. A further evolvement of the SMS standard is the more recent multimedia message service (MMS) standard. MMS messaging supports the transmission and reception of more complex and memory hungry media, such as video sequences and higher quality images.

A problem with both SMS and MMS messaging is that a mobile phone user generally has to perform a large number of steps to compose an SMS/MMS message. For example, when composing a MMS message comprising a video sequence, the video sequence has to be recorded, stored locally onto the mobile phone, and appended to the MMS message, before the MMS message can be sent to an intended recipient.

A proposed solution to the tedious and time consuming compilation of SMS/MMS messages is disclosed in U.S. Patent Application Publication No. 2004/0019487. A user is able to compose, send and retrieve SMS or MMS messages using a multi-modal interface (e.g. a grammar-based speech engine, a touch screen, or a similar input device), which allows the user to compile the SMS/MMS message with significantly less effort in a fraction of the time required by conventional methods.

However, such a system is not suitable for use in a general mobile phone, as the multi-modal functionalities consumes a large amount of memory and computational power, resulting in implementation issues in mobile phones with limited memory and processing power. Further, a mobile device using a grammar-based speech engine, for example, is generally limited to only one language, resulting in expensive customizations when releasing new mobile phone models spanning different languages.

There is therefore a need for an improved method of providing a mobile messaging service.

### SUMMARY

According to an aspect of the invention, there is provided a messaging method for a communication network, comprising the steps of receiving a request from a first communication device for sending a video message intended for a second communication device, transmitting a video message initiation to the first communication device, receiving a live feed video signal from the first communication device, storing the received video signal as a video message, for each video message transmitting a notification of the video message to the second communication device, and upon receipt of a request from the second communication device for receiving the video message, transmitting the video message to the second communication device.

In the context of the present invention, the expression “live feed video signal” is defined to mean a video sequence that is streamed from or to a communication device. Thus, according to the invention, the video message is not stored locally onto the communication device, except for some smaller caching that might be necessary due to implementation constraints of the communication method or device used. Therefore, the memory constraints for the communication devices can be set much lower than according to prior art.

Further, because the communication device does not store the video messages locally, the video messaging method according to the present invention uses a limited amount of the communication device's processing power, thus lowering the computational capacity constraints for the communication devices. It is therefore possible to implement the method according to the present invention even in an environment where communication devices having limited memory and processing power are used.

According to one embodiment of the present invention, a notification of the video message is generally transmitted to the second communication device after the live feed video signal is stored as a video message. When receiving the video message notification, the user of the second communication device is instructed how to retrieve and view the video message. If the user of the second communication device decides to receive the video message, to the user may optionally store the video message locally onto the second communication device.

Another advantage of the present invention is that the tedious and time consuming steps for compiling a MMS message, for example, according to prior art can be omitted. The user of a communication device only has to send a request to send a video message to an intended communication device, after which the user will be invited, by means of the video message initiation, to record a video sequence which will be delivered to the intended communication device. This is especially advantageous in the case where the user of the communication device is a novice user having limited knowledge of how to handle a communication device, or where the user has limited reading and writing skills. Further, it will, according to the present invention, be simple to invite a user to record a video sequence in any of a plurality of different languages. This is because the communication device need not locally implement any language related execution steps. Another further advantage with the present invention is flexibility, as functions programmed into an end-user device cannot be changed easily, whilst server based menus can be updated/modified based on user behavior.

The request for sending a video message can comprise information about the intended receiving second communication device. The request might also be appended with a control command that for example contains information about the type of message that a user wants to send (i.e. video message), delivery options, etc. Also, the control command might be a reply command, such as in a case where the user of the second communication device wants to reply to the video message sent from the user of the first communication device. In such a case, the user of the second communication device might be invited to reply to the video message, for example after receiving/viewing the video message, and at that point send a request for sending a video message, where the request has an appended reply command. Thereafter, the first and second communication devices “swap places”, such that the steps indicated to comprise interactions with the first communication device are preformed by the second communication device, and vice versa.

Preferably, the messaging method is performed by a messaging server. Also, at least one of the communication devices is a mobile terminal, such as a mobile telephone, a PDA (Personal Digital Assistant), a wireless laptop, or a similar device. Accordingly, the communication between the mobile terminals and the messaging server is preferably preformed over a mobile communication network.

In an embodiment, the video message initiation is a video prompt. The video prompt might be transmitted from the messaging server to the first communication device as a live feed video prompt. Alternatively, the video prompt might be pre-stored onto the communication device (such as for example in the case with an intelligent client implemented onto a communication device), whereby the video message initiation is a command that trigger the pre-stored video prompt. Such a command may alternatively trigger a GUI of the first communication device to invite the user to record the video sequence.

In another embodiment, the stored video message comprises an audio portion and a video portion, and the video message transmitted to the second communication device only comprises the audio portion of the video message. This is especially advantageous when dealing with mobile terminals adapted to different communication standards. An example is the case where the transmitting first communication device is a 3G mobile phone, and the receiving second communication device is a 2G mobile phone. Here, it is necessary to only deliver the voice portion of the video message as the 2G mobile phone might be incapable of displaying a video sequence.

Accordingly, it is possible to automatically select if the delivered video message should only include the audio portion, allow the user of the second communication device to select if he wants to receive only the audio portion, and/or inform the user of the first communication device that the second communication device is incapable of displaying a video sequence, such that the user can take appropriate measures. Further, it would be possible to only include still images extracted from the video portion of the video message when providing the video message to the second communication device.

Further, it is advantageous if the notification of the video message is in the form of an SMS message, an MMS message, a WAP-push message, or a similar standardized message. In such a case, the SMS message at least contains instructions of how to retrieve the video message, such as the address to the messaging server storing the video message.

According to another aspect of the present invention there is provided a messaging server for a communication network, the messaging server comprising means for receiving a request from a first communication device for sending a video message intended for a second communication device, means for transmitting a video message initiation to the first communication device, means for receiving a live feed video signal from the first communication device, means for storing the received video signal as a video message, means for, for each video message, transmitting a notification of the video message to the second communication device, and means for upon receipt of a request from the second communication device for receiving the video message, transmitting the video message to the second communication device.

The messaging server provides for, in a similar manner as describe above, a user with limited knowledge of messaging to transmit a video message to an intended recipient in a more convenient manner than according to prior art.

Further, the messaging server as described above might together with at least a first and a second communication device form part of a mobile communication system.

Additionally, the above-mentioned and other objects of the present invention are achieved through a computer program adapted to run on a messaging server according to the present invention.

According to a still further aspect of the present invention there is provided a computer program product comprising a computer readable medium having stored thereon computer program means for causing a computer to provide a messaging service, wherein the computer program product comprises code for receiving a request from a first communication device for sending a video message intended for a second communication device, code for transmitting a video message initiation to the first communication device, code for receiving a live feed video signal from the first communication device, code for storing the received video signal as a video message, code for transmitting a notification of the video message, for each video message, to the second communication device, and code for transmitting the video message to the second communication device responsive to receiving a request from the second communication device to receive the video message.

The computer is preferably a messaging server, and the computer readable medium is one of a removable non-volatile random access memory, a hard disk drive, a floppy disk, a CD-ROM, a DVD-ROM, or a similar computer readable medium known in the art.

### BRIEF DESCRIPTION OF THE DRAWINGS

These and other aspects of the present invention will now be described in more detail, with reference to the appended drawings showing currently preferred embodiments of the invention, in which:

FIG. 1 illustrates a block diagram of a mobile communication system comprising a plurality of mobile terminals and a messaging server adapted to perform a messaging method according to one embodiment of the present invention; and

FIG. 2 is a flow chart illustrating the method steps according to one embodiment of the present invention.

### DETAILED DESCRIPTION

The present invention will now be described more fully hereinafter with reference to the accompanying drawings, on which currently preferred embodiments of the invention are shown. This invention may, however, be embodied in many different forms and should not be construed as limited to the embodiments set forth herein. Rather, these embodiments are provided for thoroughness and completeness, and fully convey the scope of the invention to those of ordinary skill in the art.

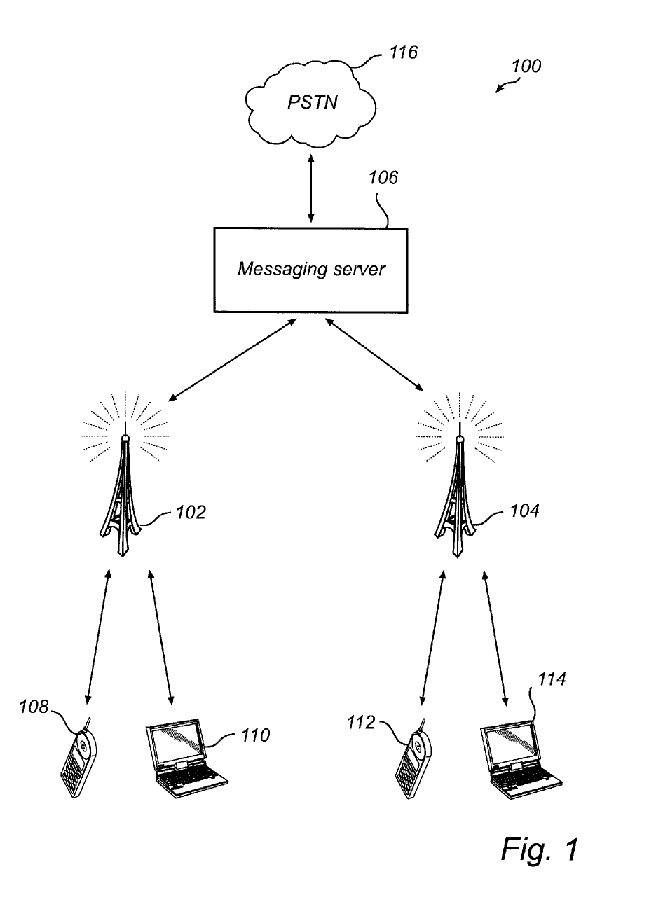

Referring now to the drawings and to FIG. 1 in particular, there is depicted a mobile communication system 100 comprising two base stations 102, 104 in connection with a messaging server 106. Each of the base stations 102, 104 are each connected with two different mobile terminals 108, 110, and 112, 114, respectively. Those of ordinary skill in the art will understand that it is possible to include more than the illustrated number of mobile terminals and base stations. The mobile terminals 108, 110, 112, 114 may be different types of mobile terminals, such as for example a combination of mobile phones, personal computers, laptops, PDAs (Personal Digital Assistants), and other communication devices with a user interface and a capability of connecting to one of the base stations 102, 104. Generally, a communication device used in a mobile communication system 100 according to the present invention comprises a camera, such as a video camera, for recording a video sequence.

Generally, the connections between the mobile terminals 108, 110, and 112, 114 and the base stations 102, 104, and the connections between the base stations 102, 104 and the messaging server 106 are wireless connections, such as a mobile communication network configured in accordance to the GSM or CDMA (Code Division Multiple Access) standard. Another example can be a WiFi/GSM combination, GSM/WiFi (WiMAX, UWB, etc.) or a WiFi adapted IP network

As understood by those of ordinary skill in the art, it is possible to apply the invention in a mobile communication system 100 configured to conform with different wireless communication standards. Further, the connection between the base stations 102, 104 and the messaging server 106 can be wired communications, in a similar manner as a connection between the messaging server 106 and a PSTN 116 (Publicly Switched Telephone Network). Alternatively, the messaging server 106 can be connected directly to a LAN (Local Area Network), a WAN (Wide Area Network), or the Internet.

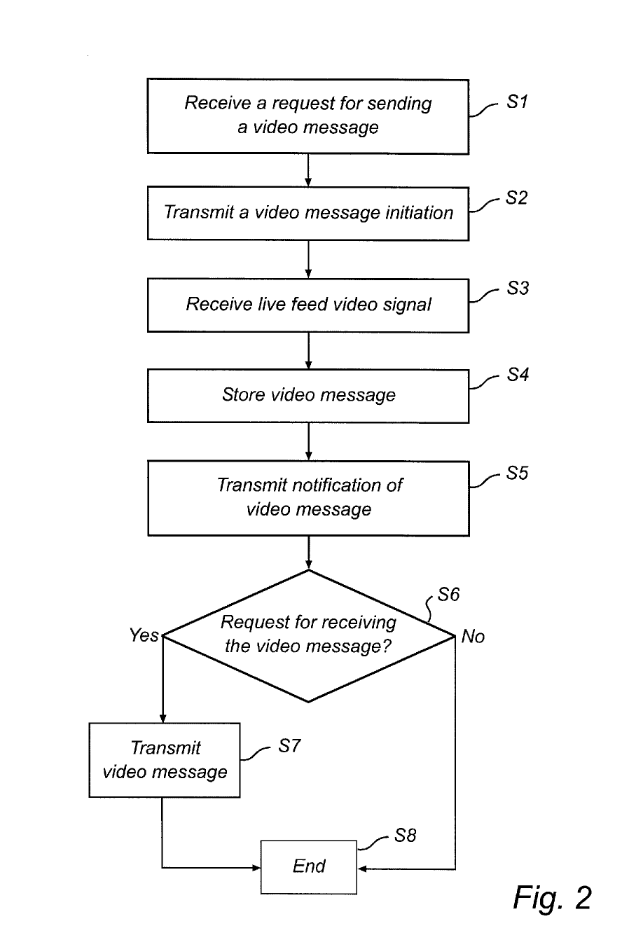

According to the present embodiment, the messaging server 106 comprises means for performing a messaging method according to the present invention. The messaging method is described in more detail below in relation to FIG. 2.

Further, the messaging server 106 can comprise processing means (not shown) such as a controller including a microprocessor, a microcontroller, a programmable digital signal processor or another programmable device. The processing means can also be provided by a multi purpose server computer. As an alternative, a messaging server 106 can be incorporated with one or both of the base stations 102, 104, and adapted to use the processing means included in a base station for performing the messaging method.

By way of example, the operational steps S1-S8 preformed in a mobile communication system 100 for sending a video message from a communication device to another communication device, e.g. between mobile terminal 110 and mobile terminal 112, are illustrated in FIG. 2.

In step S1, the messaging server 106 awaits a request from the mobile terminal 110 for sending a video message to an intended recipient, i.e. the mobile terminal 112. When the messaging server 106 receives the request, information comprised in the request is extracted and analyzed by the messaging server. In one implementation, the user of the mobile terminal 110 can simply include a prefix preceding the mobile phone number of the intended recipient (i.e. mobile terminal 112). If for example the mobile phone number of the recipient is ‘0707-555666’, and the prefix is ‘*’, the complete request transmitted from the mobile terminal 110 to the messaging server 106 is simply ‘0707-555666’. In this case, the messaging server recognize the prefix, ‘*’, stores the mobile phone number of the recipient, ‘0707-555666’, and proceeds to step S2. The request might also include a control command regarding e.g. delivery options, etc.

In step S2, the messaging server 106 transmits a video message initiation in the form of a video prompt to the mobile terminal 110 in response to the received request. As mentioned above, the video message initiation can also activate a user interface of the mobile terminal 110, or trigger a pre-stored video prompt stored locally onto the mobile terminal 110, such as for example with an intelligent client implemented onto a communication device. Such an intelligent client might be implemented using, for example, platform independent technology, such as JAVA or the like. Further, it would be possible to include more information with the video prompt, such as for example short commercial video advertisements, or the like. Alternatively, an audio message and optionally a still image can be transmitted to the mobile terminal 110. The video prompt preferably includes a short, 5-10 seconds, instruction to the user of the mobile terminal 110 on how to record a video sequence.

In step S3, upon being presented with the video prompt, the user of the mobile terminal 110 records the video message, and the video message is transmitted to the messaging server 106 that receives the video sequence as a live feed video signal. The video sequence is not stored locally onto the mobile terminal 110, but is instead transmitted directly to the messaging server 106. However, in some cases it might be necessary to cache a small portion of the video signal onto the mobile terminal 110. The size of such a cache memory comprised in a mobile terminal could be adapted in accordance with the communication method used by the mobile communication system 100.

In step S4, the video signal transmitted from the mobile terminal 110 to the messaging server 106 is stored onto the messaging server 106. For the purpose of storing a plurality of video messages, and other information, the messaging server 106 is provided with a computer writable media, such as a hard-drive or similar writable media as known by those of ordinary skill in the art. The server generally organizes the video message from the mobile terminal 110 together with the related control command and the mobile phone number of the intended recipient. The organization is preferably done using a database structure.

In step S5, the messaging server 106 transmits a notification of the stored video message to the intended recipient, i.e. mobile terminal 112. The messaging server 106 generally always transmits a notification to the mobile terminal 112. However, communication errors might of course, as understood by those of ordinary skill in the art, stop the notification from arriving at the mobile terminal 112. The notification of a video message is preferably sent as an SMS message, an MMS message, a WAP-push message, or a similar standardized message, and preferably at least includes information on how to receive the video message. Alternatively, the type of method used for delivering a notification of a video message can depend on the control command provided by the user of the mobile terminal 110.

In step S6, the messaging server 106 awaits a request from the mobile terminal 112 for receiving the video message stored onto the messaging server 106. A user of the mobile terminal 112 is given the option to ignore the notification message. If the user of the mobile terminal 112 ignores the notification message, the messaging server completes in step S8. However, if the user of the mobile terminal 112 instead follows the instructions in the notification message, and sends a request to the messaging server 106 for receiving the video message, the messaging server continues to step S7.

In step S7, the messaging server 106 transmits the video message to the mobile terminal 112. The video message is transmitted as a streaming video signal, such as a live feed video signal. Thus, it is not necessary to store the video message locally onto the mobile terminal 112. However, it might be possible to give the user of the mobile terminal 112 the option to store the video message locally onto the mobile terminal 112. As described in relation to step S2, it would be possible to include a short commercial video advertisement with the delivered video message.

After the complete video message is transmitted to the mobile terminal 112, or the user of the mobile terminal 112 decides to end the reception/downloading of the video message, or due to communication errors, the messaging server completes in step S8.

However, it is possible to provide the user of the mobile terminal 112 with the option to reply to the video message. In such a case the user of the mobile terminal 112 provides a new request for transmitting a new video message to a new intended recipient (i.e. mobile terminal 110 when replying to the video message). It would also be possible to include multiple recipients when replying to a video message, or generally when transmitting a video message. Further, it can be possible to forward a video message, and perform similar functions with the video message as when sending an email message.

In conclusion, there is according to the present invention provided a messaging method, in a communication network, between a first communication device and a second communication device. The video message is generally not stored locally onto the communication device (except for a small caching), resulting in the possibility to lower memory and processing constrains associated with the communication device.

It is important to note that while the present invention has been described in the context of a messaging server method, those of ordinary skill in the art will appreciate that the processes of the present invention are capable of being distributed as computer program instructions on a computer readable medium, and that the present invention is not limited to any particular type of signal bearing media actually used to carry out the distribution. Examples of suitable computer readable media include recordable-type media, such as a floppy disk, a hard disk drive, a RAM, CD-ROMs, DVD-ROM's, and transmission-type media, such as digital and analog communications links, wired or wireless communications links using transmission forms, such as radio frequency and light wave transmissions, for example. The computer readable media may take the form of coded formats that are decoded for actual use in a particular data processing system.

Further, those of ordinary skill in the art will realize that the present invention is not limited to the preferred embodiments described above. On the contrary, many modifications and variations are possible within the scope of the appended claims. For example, it is possible to include multi-modal functionalities with the messaging server, such as a grammar-based speech engine for recognizing a speech command provided by a user of a mobile terminal, for example, and transmitting the command to the messaging server. Further, it is possible to deliver only an audio portion of the video message to the intended recipient. This is advantageous when sending a video message to a communication device that is not capable of rendering a video sequence, or when a high speed communication network is not available (e.g. switching between 3G and 2G mobile communication standards).

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of transmitting messages in a communication network, the method comprising:
receiving a request from a first communication device to send a video message to a second communication device;
transmitting a video message initiation to the first communication device;
receiving a live feed video signal from the first communication device;
storing the received video signal as a video message;
for each stored video message, transmitting a notification to the second communication device indicating the presence of the video message; and
transmitting the video message to the second communication device responsive to receiving a request from the second communication device to receive the video message.

2. The method of claim 1 wherein the messaging method is performed by a messaging server.

3. The method of claim 1, wherein the video message initiation comprises a video prompt.

4. The method of claim 1, wherein the communication network is a mobile communication network.

5. The method of claim 1, wherein the stored video message comprises an audio portion and a video portion, and wherein only the audio portion of the stored video message is transmitted to the second communication device.

6. The method of claim 1, wherein the notification of the video message comprises at least one of an SMS message, an MMS message, and a WAP-push message.

7. A messaging server for a communication network, the messaging server comprising:
means for receiving a request from a first communication device to send a video message to a second communication device;
means for transmitting a video message initiation to the first communication device;
means for receiving a live feed video signal from the first communication device;
means for storing the received video signal as a video message;
for each stored video message, means for transmitting a notification to the second communication device indicating that the video message is stored; and
responsive to receiving a request from the second communication device for the stored video message, means for transmitting the stored video message to the second communication device.

8. The messaging server of claim 7 wherein the video message initiation comprises a video prompt.

9. The messaging server of claim 7 wherein the communication network comprises a mobile communication network.

10. The messaging server of claim 7 wherein the stored video message comprises an audio portion and a video portion, and wherein the means for transmitting the stored video message to the second communication device is configured to transmit only the audio portion of the video message.

11. The messaging server of claim 7 wherein the notification comprises at least one of an SMS message, an MMS message, and a WAP-push message.

12. The messaging server of claim 7 wherein the messaging server is located in a mobile communication network, and wherein at least one of the first and second communication devices comprises a mobile communication device.

13. A computer readable medium having program instructions stored thereon, the program instructions comprising:
code configured to cause a server in a communication network to receive to send a video message to a second communication device responsive to receiving a request from a first communication device;
code configured to transmit a video message initiation to the first communication device;
code configured to receive a live feed video signal from the first communication device;
code configured to store the received live feed video signal as a video message;
for each video message, code configured to transmit a notification of the video message to the second communication device; and
code configured to transmit the video message to the second communication device responsive to receiving a request from the second communication device for the video message.

14. The computer readable medium of claim 13, wherein the server comprises a messaging server.

15. The computer readable medium of 13 wherein the computer readable medium comprises at least one of a removable non-volatile random access memory, a hard disk drive, a floppy disk, a CD-ROM, and a DVD-ROM.
